(19) United States
(12) Patent Application Publication
(10) Pub. No.: US 2019/0028770 A1
(43) Pub. Date: Jan. 24, 2019

(54) MOBILE VIDEO PLATFORM METHOD AND SYSTEM WITH AUDIO CTA

(71) Applicant: SQOONY HOLDING B.V., Breda (NL)

(72) Inventors: Roel van KEMPEN, Breda (NL); Mattijs ROOZEBOOM, Breda (NL); David GOMMEREN, Breda (NL)

(21) Appl. No.: 16/040,830

(22) Filed: Jul. 20, 2018

Related U.S. Application Data
(60) Provisional application No. 62/535,982, filed on Jul. 24, 2017.

(51) Int. Cl. H04N 21/488; H04N 21/414; G06F 17/30; G06F 3/16

(52) U.S. Cl. CPC H04N 21/488; G06F 3/167; G06F 17/30817; H04N 21/41407

(57) ABSTRACT

A system for efficient, asynchronous video data delivery, comprising a mobile device and a video delivery platform, wherein said video delivery platform notifies said mobile device of availability of a video clip according to a notification message and wherein said mobile device optionally pulls said video clip from said video delivery platform according to said notification message when said mobile device is connected to a network technology that does not involve cellular telephone network data delivery. Optionally said network technology comprises WiFi. Optionally additionally or alternatively, a system for efficient, asynchronous video data delivery and display, comprising a mobile device and a video delivery platform, wherein said video delivery platform notifies said mobile device of availability of a video clip according to a notification message and wherein said mobile device pulls said video clip from said video delivery platform according to said notification message, but wherein said mobile device is only able to display said video clip according to one or more display parameters in said notification message.

### FIELD OF THE INVENTION

The present invention relates, in at least some embodiments, to a system and method for distributing video clips to mobile devices and in particular, to such a system and method in which obtaining video data by the mobile device is preferably asynchronous with video data display and which features an audio CTA (call to action).

### BACKGROUND OF THE INVENTION

Mobile devices are becoming increasingly the computational device of choice for many users. However mobile devices have some drawbacks with regard to downloading and displaying video data: video storage is limited and video providers often want to be able to control the number of times that video playback is possible and/or to prevent unauthorized sharing of video data, so video providers often prefer streaming video. However, mobile service providers, such as cellular telephone companies, often charge excessively for downloading the large amounts of data required to display a video, yet often bandwidth is quite limited. Streaming can therefore be an unpopular choice for obtaining video data, particularly since many mobile device users prefer to obtain data through WiFi, a connection which is often free or at least not metered to the extent that cellular data is.

Various attempts to provide video data in a more efficient manner have been described, but none of them overcome all of the above drawbacks. For example, US Published Application No. 20060277271 to Morse et al describes a system and method for pre-fetching content. Unfortunately this system and method does not provide for adequate control over the video data, such that video data providers would not have sufficient safeguards. US Published Application No. 20140171204 to Cox et al describes a method for asynchronous video delivery as part of playing a game, but once delivered, there are insufficient safeguards over the video data. This application also does not address the problems associated with cellular telephone network data delivery.

### SUMMARY OF THE INVENTION

None of the above described background art references teaches or suggests a system and method for asynchronous video data delivery and display that overcomes the problems associated with cellular telephone network data delivery. Furthermore, none of the above described background art references teaches or suggests a system and method for asynchronous video data delivery and display that overcomes the problems associated with lack of control over video data once provided to a mobile device. Also, none of the above described background art references teaches or suggests a system and method for asynchronous video data delivery and display that provides an audio CTA (call to action).

The present invention, in at least some embodiments, overcomes these drawbacks of the background art by providing a system and method for efficient, asynchronous video data delivery and display, that provides flexibility in terms of the network and technology used for video data delivery. For example, optionally the mobile device may only download video data when in contact with WiFi or another network technology that does not involve cellular telephone network data delivery. Optionally, delivery through cellular telephone network data systems may be used. Preferably, an audio CTA (call to action) enables the user to purchase one or more products, or to take some other action, in regard to the video.

The present invention, in at least some embodiments, also provides a system and method for efficient, asynchronous video data delivery and display, that enables the video data owner or originator to control when, how, to whom and for how long the video data can be displayed on the mobile device.

Optionally, the system and method also provides interactive videos for the video clips, for example optionally including a CTA (call to action) functionality that links to and/or launches external content (such as an external website for example) or in-app content. Optionally the content includes but is not limited to an external website, a landing page, a “click to call” to perform an internet call or chat, or a telephone call or chat, an email, another video, an audio file and the like.

Optionally video customization, including but not limited pre, post or mid roll, is added. A non-limiting example of such customization is adding an ad (advertisement).

Unless otherwise defined, all technical and scientific terms used herein have the same meaning as commonly understood by one of ordinary skill in the art to which this invention belongs. The materials, methods, and examples provided herein are illustrative only and not intended to be limiting.

Implementation of the method and system of the present invention involves performing or completing certain selected tasks or steps manually, automatically, or a combination thereof. Moreover, according to actual instrumentation and equipment of preferred embodiments of the method and system of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method and system of the invention could be described as being performed by a data processor, such as a computing platform for executing a plurality of instructions.

Although the present invention is described with regard to a “computer” on a “computer network”, it should be noted that optionally any device featuring a data processor and the ability to execute one or more instructions may be described as a computer, including but not limited to any type of personal computer (PC), a server, a cellular telephone, an IP telephone, a smart phone, a PDA (personal digital assistant), a thin client, a mobile communication device, a smart watch or other wearable that is able to communicate externally, or a pager. Any two or more of such devices in communication with each other may optionally comprise a “computer network”.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

Figure IA shows a non-limiting, illustrative example of a system according to at least some embodiments of the present invention;

Figure IB shows a non-limiting, illustrative example of a system according to at least some embodiments of the present invention, featuring communication with a customer computer;

Figure IC shows a non-limiting, illustrative example of a system according to at least some embodiments of the present invention, featuring communication with a mobile device;

FIG. 2 shows a non-limiting exemplary implementation of an uploading system according to at least some embodiments of the present invention;

FIG. 3A shows a non-limiting exemplary implementation of an upload process according to at least some embodiments of the present invention;

FIG. 3B shows a non-limiting exemplary implementation of a transcoding process according to at least some embodiments of the present invention;

FIG. 4A shows a non-limiting exemplary implementation of an uploading process according to at least some embodiments of the present invention;

FIG. 4B shows a non-limiting exemplary implementation of a notification flow according to at least some embodiments of the present invention;

FIG. 4C shows a system which is a variation on the system of FIG. 4B;

FIGS. 5A-5C show optional implementations of the system with a CDN (content delivery network) according to some embodiments of the present invention;

FIGS. 6A-6D show optional, exemplary flows for determining when and to whom to transmit content;

FIGS. 7A-7B show exemplary methods for setting up batch transmissions;

FIGS. 8A-8B show an exemplary method for content playback involving a QR code and/or barcode;

FIGS. 9A-9B show an exemplary method for content playback according to a geographical location; and

Figures. I0A-I0B show an exemplary method for content playback with an audio CTA (call to action).

### DETAILED DESCRIPTION OF SOME EMBODIMENTS

Figure IA shows a non-limiting, illustrative example of a system according to at least some embodiments of the present invention. As shown, a system 100 comprises a server 102 and a mobile device 104, which are in electronic communication through a computer network 106. The various components of server 102 may optionally be described as a platform 122. Computer network 106 is preferably a network such as the Internet, which may optionally be delivered through various mechanisms as described herein. In this embodiment, server 102 optionally receives uploaded videos and is able to provide such videos to mobile device 104 through computer network 106. In other embodiments shown below, uploaded videos are uploaded to an external storage and delivery system, such as a CDN (content delivery network) for example (not shown).

Computer network 106 preferably features at least two delivery mechanisms, including a cellular data network and a wireless LAN (local area network; neither shown), for provision of videos to mobile device 104. Non-limiting examples of cellular data networks include a GSM based network (e.g., GPRS, EDGE, UMTS, HDSPA/HSUPA, LTE, 3GPP, 3GPP2), CDMA-based network (CDMA2000, WCDMA, EVDO, LTE, etc.), a cellular data packet based network or any suitable cellular data connection or cellular telephony network connection that is capable of supporting data transfer. Non-limiting examples of a wireless LAN include any type of connectivity known as “WiFi”, any wireless network using 2.4 GHz UHF and 5 GHz SHF ISM radio bands, IEEE 802.11 Wi-Fi LAN, 802.16 WiMAX LAN, or any suitable WLAN.

Mobile device 104 comprises a software 108 for displaying a video to a user (not shown). The user may optionally select a delivery modality, whether cellular telephone network or wireless LAN network, through software 108, which in turn provides these instructions to server 102 for controlling delivery of the video. As a non-limiting example, software 108 can indicate to server 102 when mobile device 104 is connected to computer network 106 through the desired delivery mechanism, such that delivery of the video or videos only begins upon receipt of such signal.

Server 102, in at least some embodiments, comprises a front end 110 for receiving an uploaded video from a customer computer 112 through computer network 106. Front end 110 preferably communicates with customer computer 112 and receives the uploaded video. Optionally and preferably, customer preferences may optionally be indicated through front end 110, including but not limited to specifying a start day and/or time of display (before which the video cannot be displayed through mobile device 104) and an ending (or stop) day and/or time of display (after which the video cannot be displayed through mobile device 104). Additionally, the customer may optionally indicate through front end 110 a channel through which the video is to be displayed, as described in greater detail below, whether the video is private or public, and so forth.

Other optional parameters include but are not limited to a title, CTA (call to action), any pre/post roll (if any), advertisements or a description of the video. Optionally a video thumbnail is created at this point. Additional details are provided below.

Uploaded video is then processed by a processing engine 116, which includes transcoding capabilities, preferably at least operating system and/or device specific transcoding capabilities, but also optionally adjustable according to parameters such as the need for greater fidelity or greater compression etc, also as described in greater detail below.

After processing, a clip management engine 118 receives an indication that the video is ready and also a determination of which mobile devices 104 are to receive the video. As used herein, the terms “clip” or “video clip” are used to mean any suitable type of video data unit, optionally including a file or the like. Clip management engine 118 then preferably prepares a message to send to selected mobile devices 104 as a push notification. The message is then received by software 108 which parses the message as described in greater detail below.

According to the message parameters, software 108 is able to determine which video is to be received from server 102, whether by push, pull or a combination thereof. Software 108 also preferably determines at least the initial period (day and/or time) when the video may be displayed to the user through mobile device 104, and optionally also the end of the display period as described above. The message may also optionally indicate when the retrieval process of the video may begin, for example through a pull mechanism from software 108 to server 102, as described in greater detail below.

According to at least some embodiments, software 108 initiates the retrieval process according to the connectivity state of mobile device 104 on network 106, and specifically whether the delivery modality of network 106 is a cellular network or some other type of network, such as a wireless LAN network for example. Different modality types may optionally result in different charges, latency or have other differences which may make one such modality more desirable. For example, wireless LAN network connections are typically not metered while cellular networks typically are metered; therefore, the former may be more desirable under at least some circumstances. This process is described in greater detail below.

Next, uploaded video is received by mobile device 104 and is preferably stored on mobile device 104. Optionally and more preferably, mobile device 104 receives and stores the video before the initial display period begins, such that initially the user cannot access the video on mobile device 104. However, this also means that mobile device 104 preferably does not need to be in communication with computer network 106 while the video is being displayed to the user. Optionally, a portion of the local storage on mobile device 104 is set aside in advance, to permit future videos to be retrieved. Optionally this portion may be set as a percentage of the free space available and/or as an absolute minimum. Also optionally, the user is able to adjust this amount.

Upon watching the video on mobile device 104, the user may optionally interact with the video, for example by clicking on a CTA (call to action) indicator, such as a button, which may then optionally launch additional content, including but not limited to a landing page or another HTML document, a telephone call, an email message and so forth. Such content is optionally provided in-app or as external content, through such CTA functionality, which is provided through pre-roll or post-roll. Optionally the additional content is launched within software 108 in order to maintain the display even when mobile device 104 is not in communication with computer network 108.

Optionally such CTA functionality could be provided by “native” CTA (already in the video clip) or can be added to the video clip. The pre/post rolls may also optionally feature native or added CTAs.

According to at least some embodiments, information regarding the behavior of the user with the video is preferably passed from software 108 to an analytics engine 120 at server 102. Such user behavior optionally includes but is not limited to whether the user watched it, for how long, when the user watched it, where the user watched it (if geolocation functionality is activated), whether the user has permitted automatic video playing for this channel (through which the video is distributed) or generally for the app, and if not, how long after notification before the user requested to play the video clip; whether the user requested to access additional content through a CTA (call to action) functionality, which is described in greater detail below, and so forth.

Optionally, preferably if the user permits, information such as a telephone number associated with mobile device 104 and/or the IMEi of mobile device 104 is uploaded to server 102.

Data could optionally be analyzed at server 102 for data mining and to determine market knowledge, and/or could be provided to the customer (for example through customer computer 112) for performing data mining and/or other types of market analytics. Such analytics could optionally be specifically used, for example, for determining the efficacy and “stickiness” of native advertising (advertising delivered as content in a video clip, as opposed to separate advertising) and/or of regular pre and/or post roll advertising.

FIG. 1B shows another exemplary, non-limiting implementation of a platform according to at least some embodiments of the present invention. As shown, a platform 124 preferably comprises a data storage 126 and a load balancer 128, both of which are preferably in bi-directional communication with client computer 112. Client computer 112 is able to upload videos, thumbnails and other information to data storage 126, for example in the form of video clips to be shown, as described in greater detail below. Data storage 126 may optionally be any type of BLOB (Binary Large OBject) storage or other storage type. Optionally data objects which then provide information on the video clips to be retrieved may be stored in data storage 126 but alternatively are stored elsewhere, as described in greater detail below.

Load balancer 128 preferably distributes job requests for uploading videos and other information to a processor 130, comprising a plurality of working instances 132, of which four are shown for the sake of clarity and without any intention of being limiting. Each working instance 132 comprises a portal 134 and a worker 136. As shown in close-up 138, each portal 134 in turn comprises a platform API 140 and an admin module 144.

Admin module 144 supports an administrative console so that customer computer 112 is able to manage content, such as video clips and data about these clips, and also parameters related to customer computer 112 itself Optionally admin module 144 enables customer computer 112 to manage uploading of video content, whether through processor 130, directly to data storage 126 and/or to an external system, such as a CDN (not shown). Admin module 144 may also optionally operate parameters related to customer computer 112, for better interaction between customer computer 112 and platform API 140. Preferably, actions involving communication with processor 130 are managed by admin module 144 through platform API 140. Admin module 144 may optionally be augmented and/or replaced by software operating on customer computer 112 (not shown).

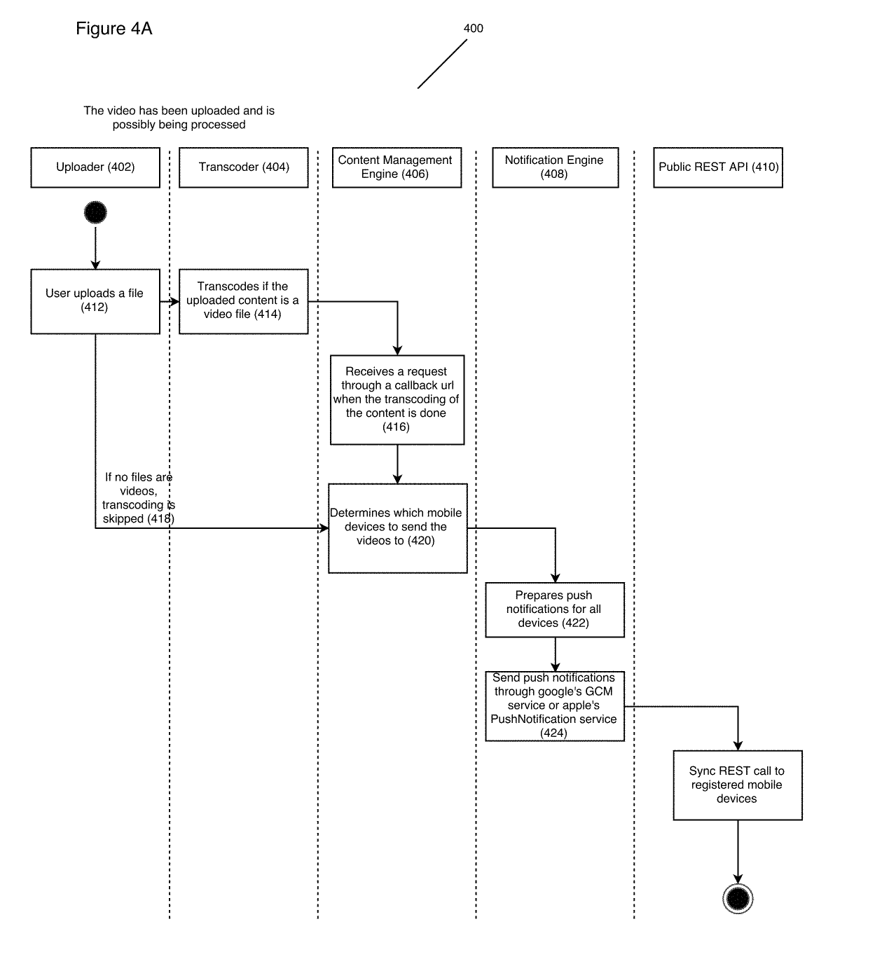

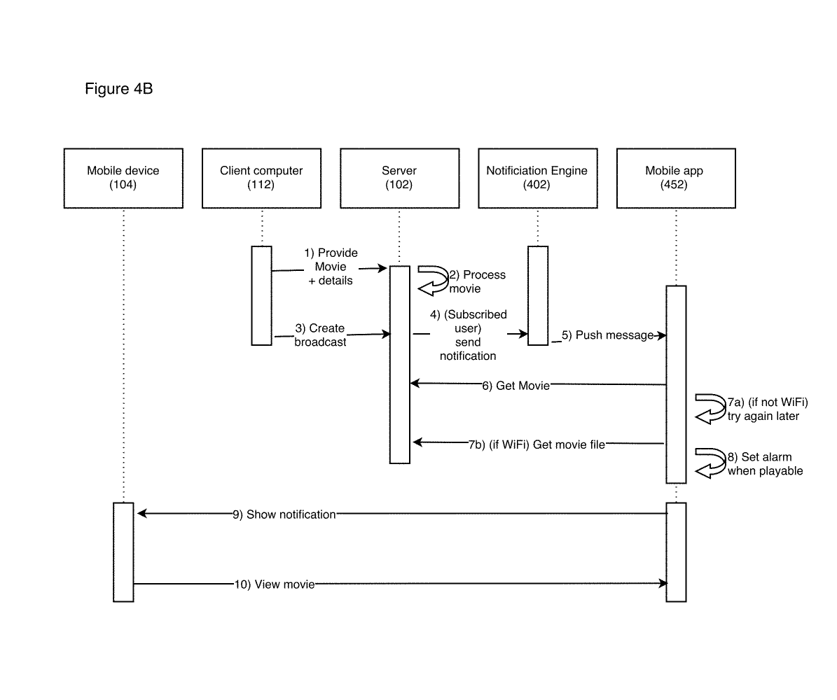

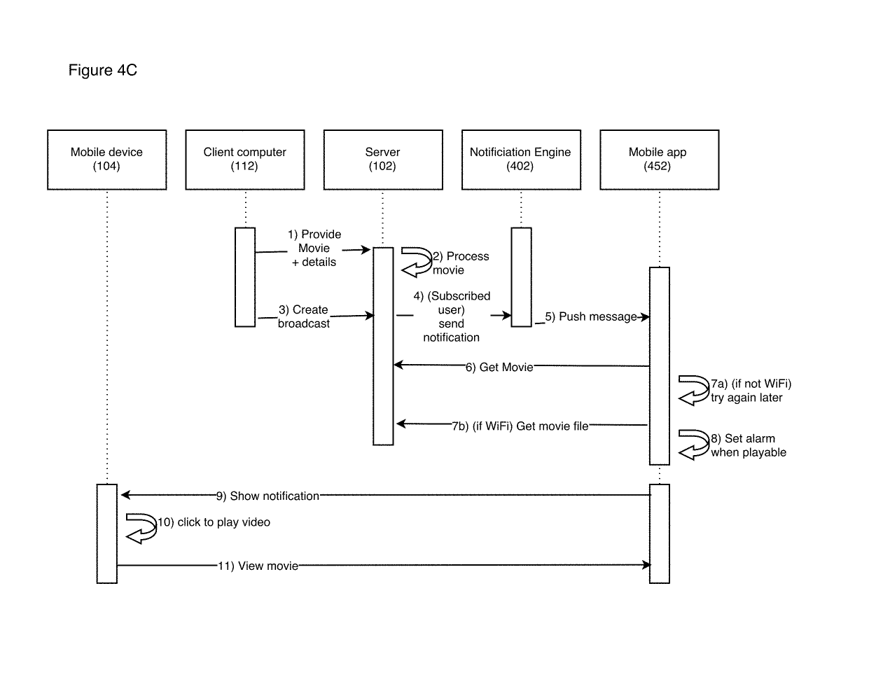

At start-up of a session, each worker 136 registers itself with a database 146. Database 146 is optionally any type of suitable database, such as an SQL database for example, for storing metadata and other information about the video clips, such as when the video clip may first be displayed for example, but preferably does not store the actual video data. Instructions for downloading the video clip by mobile device 104 (not shown) are also optionally stored in database 146, for example in the form of a JSON object; such instructions are optionally and preferably provided to a notification engine (not shown; see FIGS. 4A and 4B).

A memcache server 148 is optionally provided to maintain persistence of sessions; otherwise, at the end of each session, each working instance 132 shuts down and is restarted at the beginning of each session. Memcache server 148 optionally operates with database 146 to provide a persistence layer.

Each worker 136 preferably has two processes operating, a transcoder process and a notification process (not shown). The transcoder process performs transcoding of the uploaded video clips. The notification process relates to notification to mobile device 104, for a new video clip to be pulled from data storage 126 (not shown).

Figure IC shows platform 124 according to interactions with mobile device 104. Optionally the components of platform 124 as shown may be combined with those in Figure IB (not shown). Mobile device 104 communicates with load balancer 128 to retrieve video clips and optionally also instructions for downloading these video clips. Load balancer 128 distributes the sessions with various mobile devices 104 to one of a plurality of public AP is 142 in processor 130. Information about the video clips, optionally including instructions for retrieving the video clips, is obtained from database 146, while the actual video clips are optionally downloaded from data storage 128 (or alternatively from an external system as previously described).

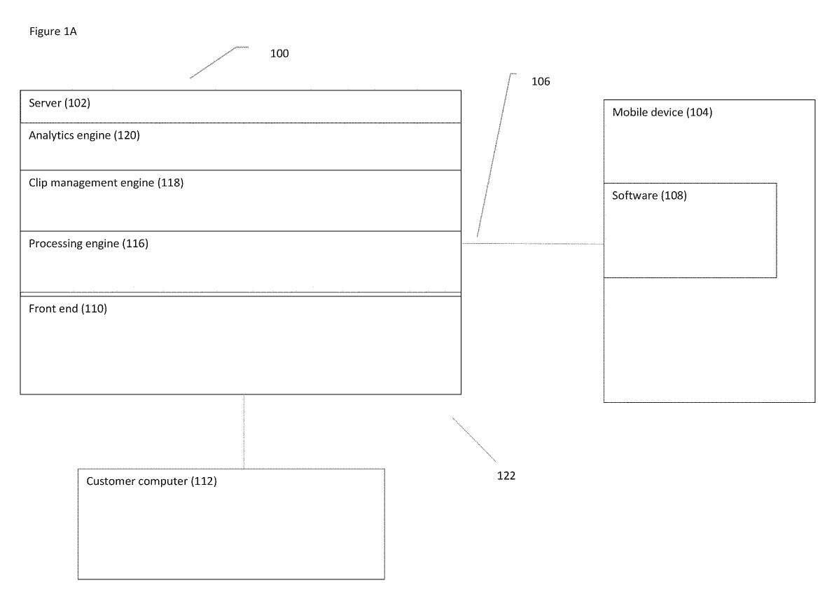

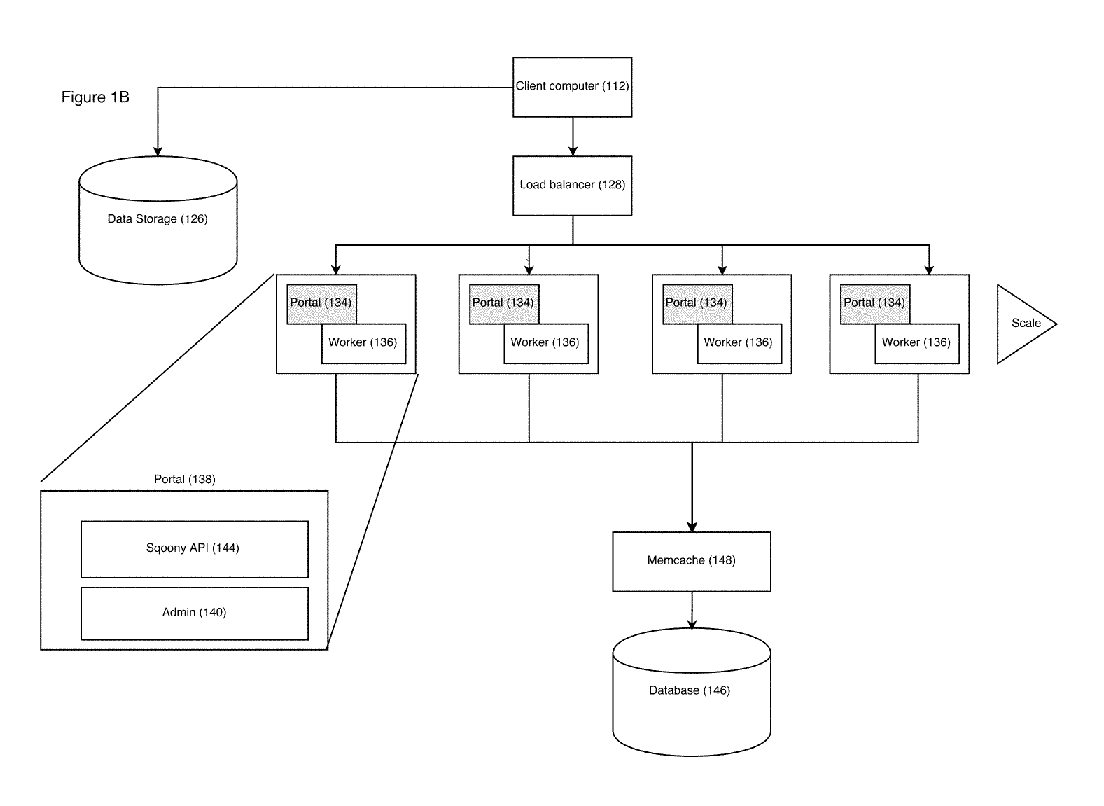

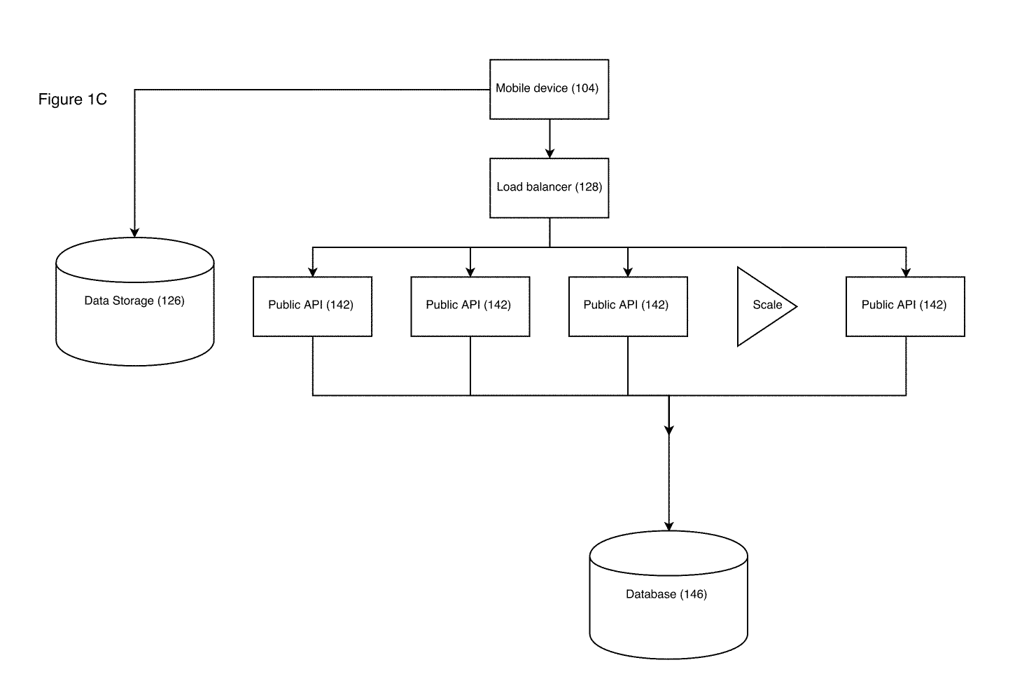

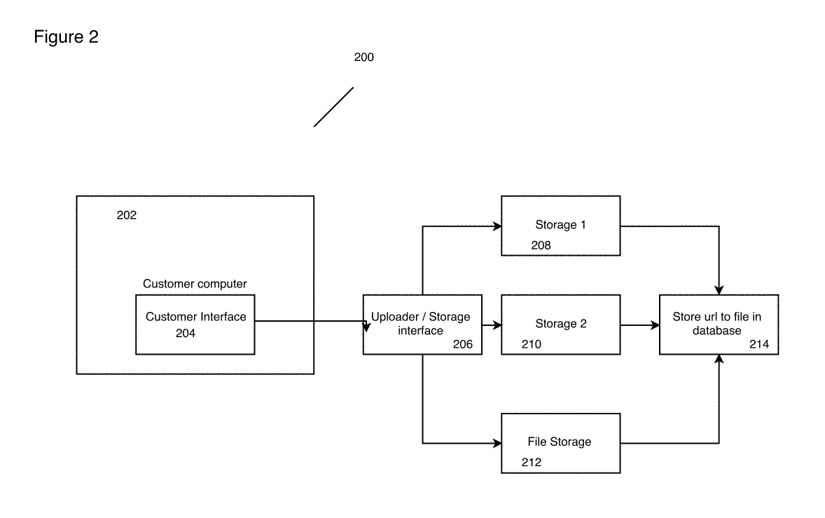

FIG. 2 shows an exemplary system according to at least some embodiments featuring a system 200. System 200 includes a customer computer 202, operating a customer interface 204. Customer interface 204 connects to an uploader storage interface 206 optionally through a network 205. Customer interface 204 enables the user to upload a video or other content and optionally also to determine various parameters related to that content. Customer interface 204 communicates with uploader storage interface 206 to upload the video or other content.

The customer may then decide whether to place it into storage 1208, storage 2210, or file storage 212. Storage 1208 and storage 2210 may optionally be two different types of storage, for example differentiate according to cost, accessibility, speed of retrieval, and other factors. They may also be differentiated according to geographical location, relative geographical location, ability to distribute over a wide geographical area, for example through a CDN or content distribution network or the like. File storage 212 is often preferably a type of storage used for archiving, which is less expensive but also has a higher latency time.

Regardless of the type of storage selected, or indeed if all three types of storage are selected, after the video has been uploaded and placed in storage then for each type of storage in which it was placed a URL is received for the file to store into a database, in stage 214. This enables the file to retrieve later from whatever type of storage it has been placed in.

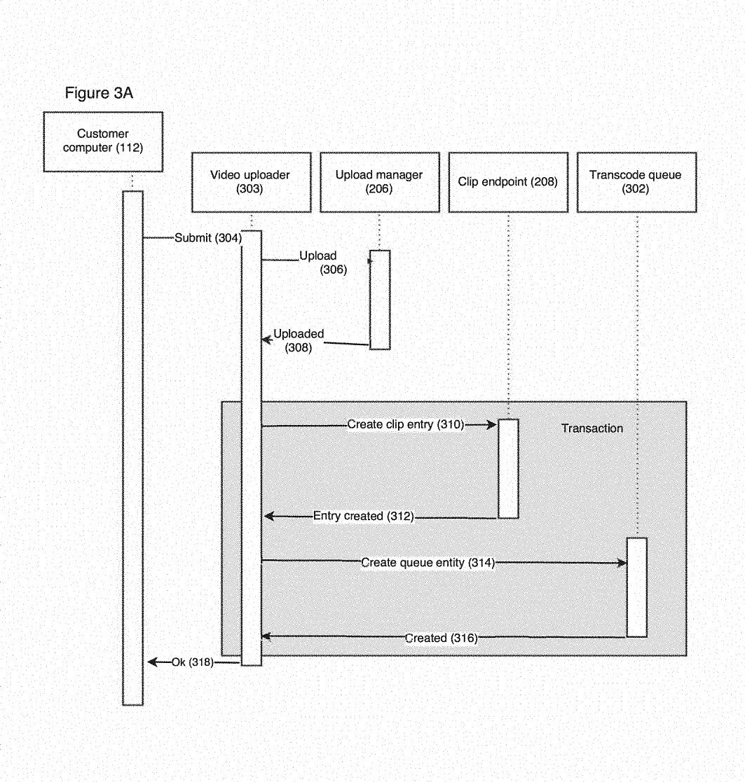

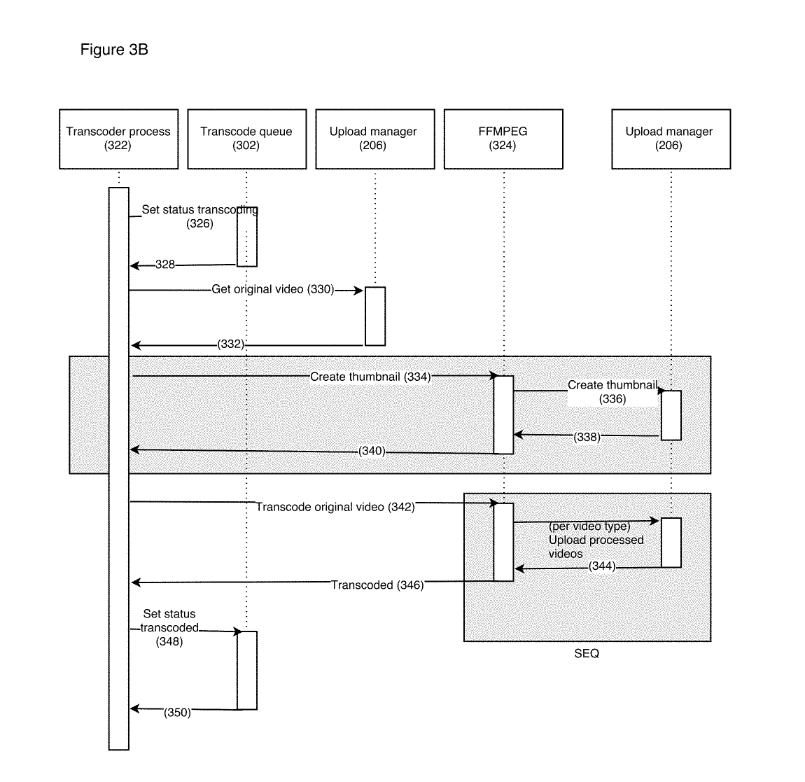

FIG. 3A shows a non-limiting exemplary implementation of an upload process according to at least some embodiments of the present invention. As shown, an upload process 300 preferably involves various entities as shown, which perform a flow to upload a video clip from customer computer 112. In stage 304, process 300 begins with customer computer 112 submitting a video clip to a video uploader 303, which may optionally include various components from front end 110, such as file uploader 202 for example. Next, in stage 306, the video clip is passed to upload manager 206. Confirmation of the successful upload is passed in stage 308 from upload manager 206 to video uploader 303; optionally, such confirmation may be passed also to customer computer 112 (not shown).

Next, a plurality of stages 310-316 is optionally performed, labeled as a “transaction” in the diagram. In stage 310, video uploader 303 creates a clip entity in database 208. In stage 312, database 208 confirms that the entity was created to video uploader 303. Video uploader 303 then instructs a transcode queue 304 to create a queue entity in stage 314. In stage 316, transcode queue 304 confirms that the queue entity was successfully created to video uploader 303. In stage 318, video uploader 303 confirms success of the entire uploading process to customer computer 112.

Any video can contain a thumbnail or a pointer to a thumbnail, such as a thumbnail URL. Optionally such a thumbnail or thumbnail pointer is provided in the video upload from customer computer 112. If the thumbnail or pointer was not provided, optionally the upload process 300 includes creating one based on the uploaded video clip, for example by taking a frame from the clip. Optionally the thumbnail or pointer is created by video uploader 303.

FIG. 3B shows a non-limiting exemplary implementation of a transcoding process according to at least some embodiments of the present invention. As shown, a transcoding process 320 preferably involves various entities as shown, which perform a flow to transcode an uploaded video clip. Optionally such transcoding is at least operating system and/or device specific. Information for determining how transcoding is to be performed is preferably stored in a transcoding database (not shown), which may optionally be part of database 208, or may optionally be located at server 102 or externally to server 102 (not shown).

In stage 326, a transcoder process 322 sends a message to transcode queue 304 to obtain the next queue entity in the queue, thereby setting the transcoding process status for that entity to “transcoding”. In stage 328, transcode queue 304 sends the identity of the next queue entity to be transcoded. In stage 330, transcoder process 322 sends the identity of the next queue entity to upload manager 206 in order to obtain the uploaded video clip. In stage 332, upload manager 206 returns the video clip to transcoder process 322.

In stage 334, transcoder process 322 sends the video data to a transcoder 324, with a request to create a thumbnail. Transcoder 324 optionally performs transcoding according to one or more parameters in the transcoding database (not shown); optionally there are multiple different transcoders 324 for different types of transcoding. Non-limiting examples of suitable CODECS include MPEG-4, as well as any CODEC implemented by FFMPEG, preferably including such file types as .mp4, .mov, .avi and .wmv; as well as any suitable transcoding service, such as the transcoding service of Amazon or any other transcoding service.

In stage 336, transcoder 324 creates the thumbnail and sends it to upload manager 206, which in turn transmits it to transcoder process 322 in stage 340. In stage 338, optionally a thumbnail is created by upload manager 206 if one is not already uploaded. The thumbnail is preferably created from one of the initial frames, say in the first second, but optionally and preferably not one of the very first frames, to avoid creating a thumbnail during a video “fade-in” visual transition. As a non-limiting example, the thumbnail is optionally created from the 24^{th} video frame. The video thumbnail is then provided to transcoder 324 for transcoding.

In stage 342, transcoder process 322 sends a request to transcode the video data to transcoder 324, which then transcodes the video data and transmits it to upload manager 206 in stage 344.

In stage 346, transcoder 324 notifies transcoder process 322 that the video data was transcoded. Transcoder process 322 notifies transcode queue 304 to set the transcoding process status for that entity to “transcoded” in stage 348. In stage 350, transcode queue 304 acknowledges completion of the request.

FIG. 4A shows an exemplary non-limiting process 400 for uploading and processing videos. The process starts with uploader 402 in which the user uploads a file 412. The process starts with the user uploading the file in stage 412. If the file is a video file then it is transcoded in stage four by transcoder 404. Other components operating on this process include a content management engine 406, a notification engine 408 and a public REST API 410. If the uploaded file from stage 412 is a video file, then transcoder 404 transcodes the file in stage 414. However, if the file or files are not video files, then transcoding is skipped in stage 418.

Continuing with the video file process, after transcoding at stage 414, a content management engine 406 receives a request via a callback URL when the transcoding of the content is done in stage 416. The callback URL enables the content management engine 406 to retrieve the transcoded data when ready; the request indicates that the content is ready to be retrieved. In any case, in stage 420, content management engine 406 determines to which mobile device is to send the videos or other files.

Once this has been done the notification engine 408 prepares push notifications for all devices in stage 422. Notification 408 then sends push notifications, for example through Google's GCM service, or Apple's push notification service, in stage 424. Optionally, another type of push notification service could be used. Next, public REST API 410 synchronizes the REST call to registered mobile devices in stage 426, by letting the registered mobile devices know that content is ready for downloading. The process then ends.

FIG. 4B shows a non-limiting exemplary implementation of a notification flow according to at least some embodiments of the present invention. In a process 450, a mobile app 452 is operated by mobile device 104. In addition, process 450 features client computer 112, server 102 and notification engine 402.

Process 450 optionally and preferably starts as customer computer 112 uploads a video in stage 1, in this example to server 102 (although as described herein different implementations are possible). Preferably scheduling and other information is also provided through customer computer 112 at this stage or at least before notifications are sent to mobile devices. In stage 2, server 102 processes the video, for example with transcoding as described herein. After processing (or optionally simultaneously with processing), in stage 3, customer computer 112 creates a broadcast by sending information to server 102 regarding when the video can first be downloaded and then viewed on mobile device 104, and also regarding which subscription channel is to be used for broadcasting information about the video.

In stage 4, server 102 sends a notification regarding the new video to notification engine 402. This notification preferably includes the location of the video storage (that is, information necessary to be able to retrieve the video), metadata about the video (length, size etc) and/or any restrictions on when the video can be displayed by mobile device 104, optionally including but not limited to an initial display date and time, and/or a finishing (end) display date and time. Server 102 may optionally indicate which channel(s) can be used to distribute the video. Preferably, notification engine 402 receives information about the channel to be used for displaying the video data before the push message is prepared, so that notification engine 402 knows which mobile devices are to receive the push message. In this sense a “channel” may optionally feature a group of specific mobile devices that are associated with a particular set or type of notification.

Notification engine 402 prepares a push message, which is then sent in stage 5. The push message may optionally direct mobile device 104 as to the location of a data object with instructions to retrieve the video or alternatively may include these instructions within the push message itself Optionally every subscriber to a particular channel, which is to receive the video, receives a push notification, for example optionally through a notification service such as Amazon SNS (Simple Notification Service).

As a non-limiting example of a message structure, the push notification optionally contains the following information:

```
{
  • “readyToAir”: true,
  • “broadCastid”: 2,
  • “channelName”: “SmrieBrand”
  • “dipUrl”: “http://videohost//somedip with SomeBrand.3gp”
  • “dipTitle”: “Soind3rand i great”,
  • “scheduledFor”: “15--2--2015 14:20:00”,
  • “durntioninSeconds”: 80
}
```

In this example, the first parameter states that a new video is available for download. The second parameter relates to the broadcaster (the provider of the video data) while the third parameter is the name of the channel that is being used for the notifications. The clipURL is a non-limiting example of a way in which the clip download address may be provided. The clip title indicates. The time and date on which the video data may optionally be first displayed is indicated as “scheduledFor”; optionally an end time and date may be provided. The length of the video is indicated as “durationinSeconds”.

Optionally, mobile device 104 operates a software client (not shown), which “wakes up” upon receiving the notification message, such that this software client may perform the following stages.

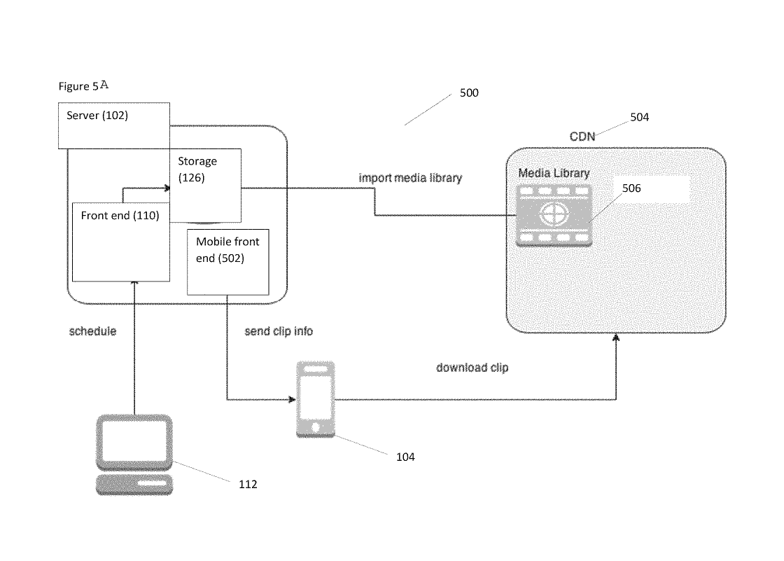

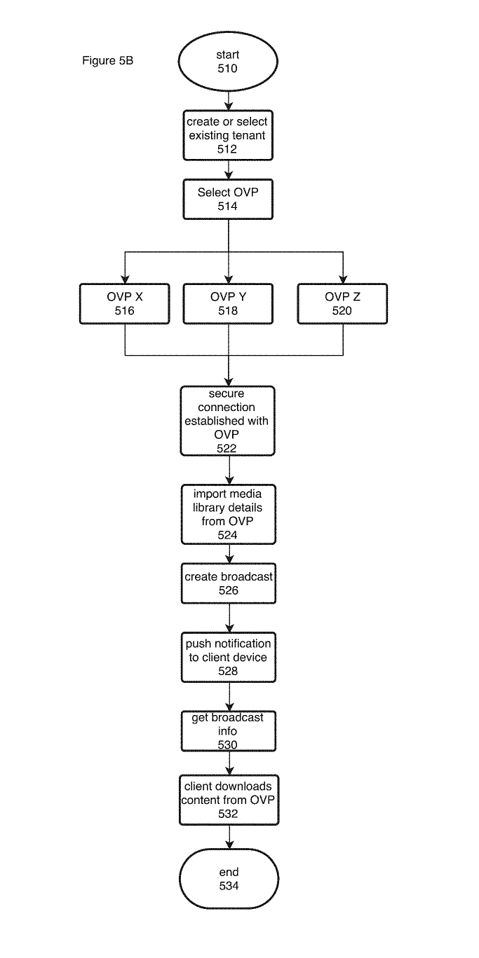

In stage 6, mobile device 104 retrieves the video according to the instructions provided, optionally from server 102 or an associated storage, and/or from another storage system as described with regard to FIG. 5. The process of pulling the video is then performed in stage 7b, although if there is no WiFi as described above, optionally mobile device 104 waits until such a computer network connection is available, as shown in stage 7a.

For example, mobile device 104 may optionally detect the availability of a LAN connection which is either not metered or less metered than a typical cellular telephone data connection. As noted above, WiFi collectively refers to a type of communication technology which is usually not metered or less metered (by “less metered” it is meant that usually data may be downloaded up to a certain ceiling or at a certain speed). Mobile device 104 may optionally determine that such a connection is available as described for example in US Published Application No. 20130155876 to Potra et al.

In stage 8, an alarm is preferably set when the movie is playable, for example by mobile device 104 or alternatively by mobile app 452. Optionally when the download is completed successfully, the local mobile device app schedules a local push notification at the “scheduledFor” date, telling the user that a video is available for watching. In stage 9, the alarm is indicated to the user through mobile app 452 and/or through having the video display start automatically (not shown). In stage 10, the video automatically starts playing. Optionally, mobile app 452 does not include a video player; instead, mobile app 452 directs an existing video player on mobile device 104 to display the video.

FIG. 4C shows a variation on FIG. 4B, with a system 454. Stages 1-9 are performed as for FIG. 4B. In stage 10, rather than starting to play the video automatically, mobile app 452 needs the user to indicate when the video is to be played, so that the user directs the video to be played by interacting with mobile app 452. In stage 11, the video starts playing. Optionally, as described above, mobile app 452 does not include a video player; instead, mobile app 452 directs an existing video player on mobile device 104 to display the video.

FIGS. 5A-C show optional implementations of the system with a CDN (content delivery network) according to some embodiments of the present invention. As previously described, in such an embodiment, uploaded videos are preferably uploaded to an external storage and delivery system, such as a CDN (content delivery network) for example (not shown).

As shown in FIG. 5A, a system 500 features server 102, with front end 110 and storage 126, in communication with client computer 112 (as previously described). Server 102 also features a mobile front end 502, which is in communication with mobile device 104. As described above with regard to notification, mobile front end 502 sends a notification to mobile device 104 when a new video is ready. Mobile device 104 then accesses the data object, such as a JSON object for example, describing the new video and any associated data, by pulling it from storage 126 through mobile front end 502. The data object preferably does not include the actual video data, also as previously described.

The data object informs mobile device 104 of the location of the stored video data: in this implementation, mobile device 104 then pulls the video data from a content delivery network (CDN) 504, preferably from a media library 506.

At least a portion of the data object is preferably constructed according to information provided by CDN 504 to storage 126, regarding the location of the video data in media library 506. This information may optionally be provided through a batch file, to import the information from CDN 504, optionally including but not limited to video file name, length, URL, thumbnail, and other meta-data. In this embodiment, the video data may optionally be uploaded to CDN 504 from client computer 112 through server 102, or alternatively may be directly uploaded to CDN 504 from client computer 112 (not shown).

As previously described, a customer upload application, such as a web application, can be used to upload videos. Another option is for bulk upload through a bulk upload mechanism such as (S)FTP. Such a bulk upload mechanism would enable client computer 112 to connect to the CDN storage of choice, such as CDN 504, via FTP and upload multiple video clips; optionally a large amount of video data could be uploaded at the same time. When the upload is ready the clips are available for scheduling. Optionally a crawler could go through already stored videos, whether at a client computer (such as client computer 112) or an external online video solution such as YouTube or Vimeo for example.

Another option is to import video information from a third party CDN, such as for example the XML import from Kaltura. The XML contains all the metadata of the clips including the URL for delivery. In order to schedule clips which are stored at a third party CDN (content delivery network) 504, server 102 needs to receive information regarding at least the following parameters (although not limited to these parameters), including the clip title and the clip URL (or any other clip storage address according to the clip storage location). Optionally, the customer could choose to upload the clip directly to CDN 504, without first passing the clip through server 102. In order for such a clip to be scheduled through server 102 as described herein, this information needs to be made accessible to server 102, for example through a connection from CDN 504 or other external storage or server. Non-limiting examples of such a connection include a direct API connection, XML import, CSV import).

The push notification “clipURL” or other clip address/location would be the one of the original clip hosting location, such as CDN 504 for example.

FIG. 5B shows an exemplary, non-limiting method for importing videos from an OVP (online video platform) according to at least some embodiments of the present invention. Such an OVP may optionally be any repository of video clips or video data.

This process starts with step 510, in which the user decides to connect to the OVP to import one or more videos or even an entire video library. In step 512 a new tenant is created or an existing tenant (publisher, customer or client) is selected. In step 514 the option is provided to choose among OVP's for retrieving the video data. In this non-limiting example, three OVPs are shown: OVP X, OVP Y and OVP Z.

The selection of a particular OVP is then made in step 516 for OVP X, step 518 for OVP Y and step 520 for OVP Z. In step 522 a secure connection is made by using the type of connection which is supported by the OVP and by using authentication details also provided by the OVP. This information is stored for this tenant and in step 524 the media library details are imported from the OVP to the platform. These details preferably include at least the video title, length, format and resource URL. This information is then stored in the platform as if this was a video which was directly upload. These imported videos are available in the create broadcast step 526 where the platform user can setup a broadcast with one of the imported or already existing videos. In step 528 a push notification is send to the client device and the client device is triggered to get the broadcast information in step 530. The client device downloads the content accordingly to the information which was sent, for example as a JSON object, in step 530. In step 532 the actual content is downloaded from the OVP resource. This process ends with step 534 after the front end client of the subscriber device has retrieved the video content.

FIG. 5C shows an exemplary, non-limiting method for importing videos from a CDN according to at least some embodiments of the present invention. The CDN may optionally be any content delivery network or content delivery service as described herein. Optionally, if a CDN is not used, some other type of data storage service may be used, in place of the CDN. Alternatively such a service may be used with the CDN. Regardless, any type of data delivery service may optionally be considered as a CDN.

This process starts with step 536, in which the user decides to connect to the CDN to import one or more videos or even an entire video library. In step 538 a new tenant is created or an existing tenant is selected. In step 540 the option is provided to choose among CDN's for retrieving the video data. In this non-limiting example, three CDNs are shown: CDN X, CDN Y and CDNZ.

The selection of a particular CDN is then made in step 542 for CDN X, step 544 for CDN Y and step 546 for CDN Z. In step 548 a secure connection is made by using the type of connection which is supported by the CDN and by using authentication details also provided by the CDN. This information is stored for this tenant and in step 550 the media library details are imported from the CDN to the platform, including at least the video title, length, format and resource URL. This information is then stored in the platform as if this was a video which was directly uploaded to the platform as previously described.

These imported videos are available in the “create broadcast” step 552 where the platform user can setup a broadcast with one of the imported or already existing videos. In step 554 a push notification is send to the client device and the client device is triggered to get the broadcast info in step 556. The client device downloads the content accordingly to the information which was sent, for example as a JSON object, in step 556. In step 558 the actual content is downloaded from the CDN. This process ends with step 560 after the front end client of the subscriber device has retrieved the video content.

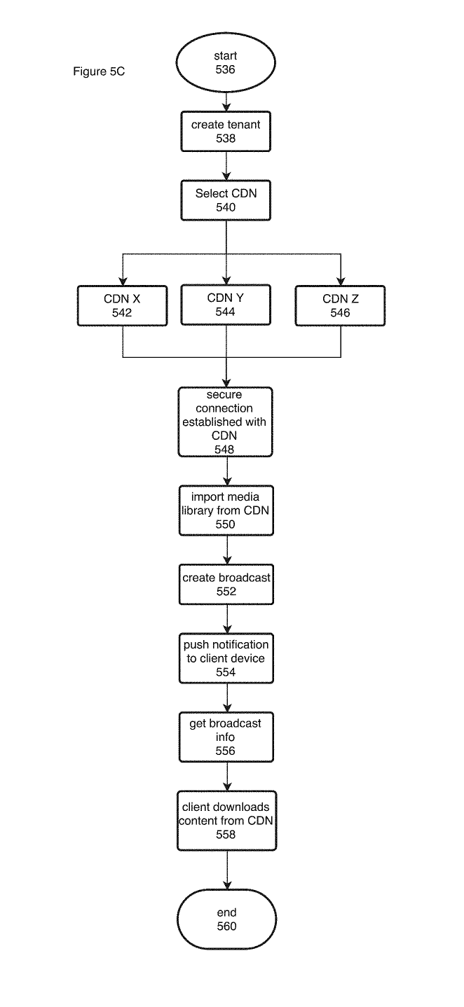

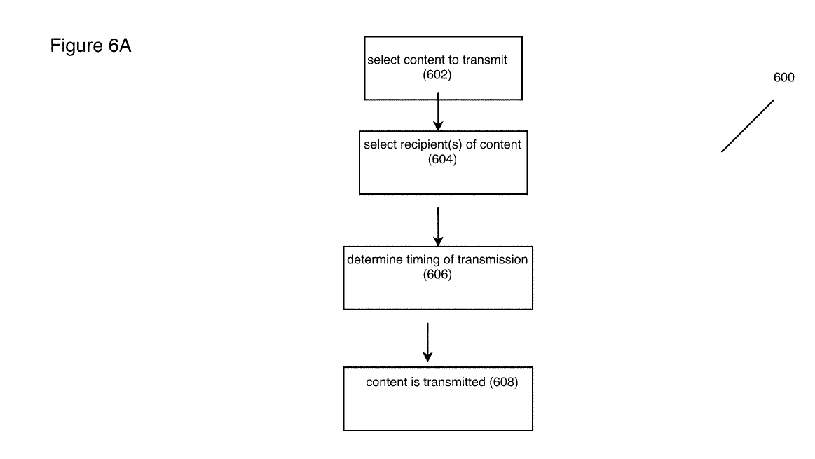

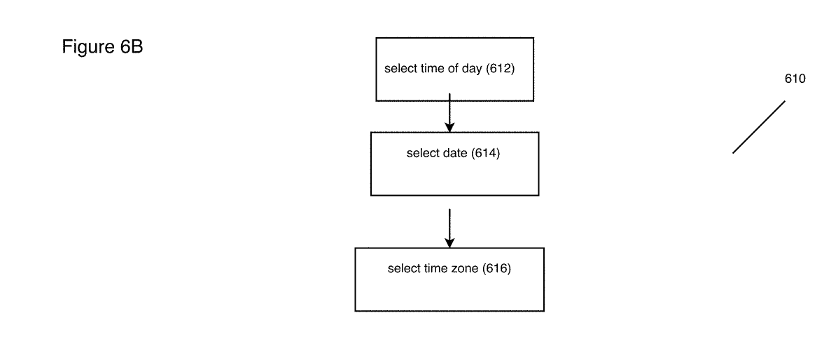

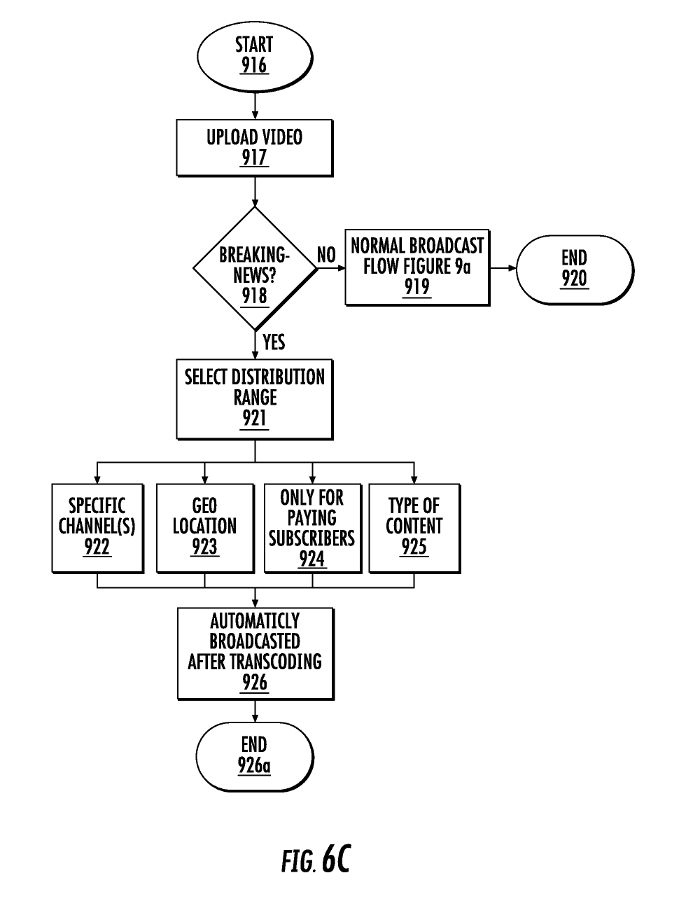

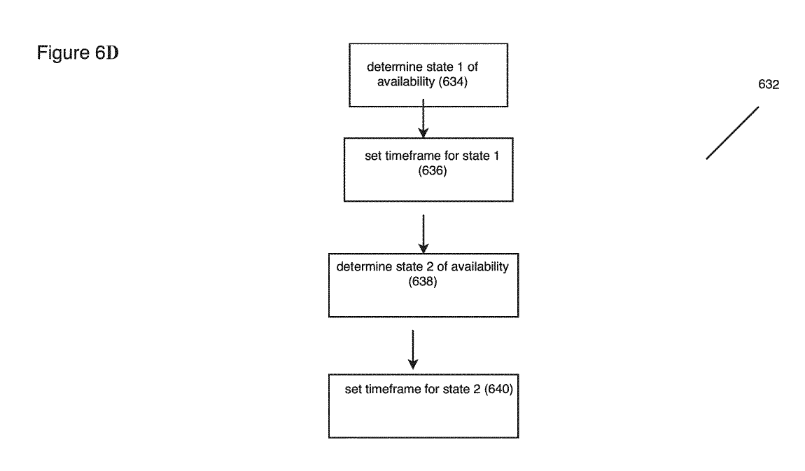

FIGS. 6A-6D show optional, exemplary flows for determining when and to whom to transmit content. FIG. 6A relates to a process 600 for determining the timing and preparation of content transmission. In stage 602 content is selected to be transmitted which may optionally comprise, for example, a video file or other files. In stage 604 the user selects the recipients of the content according to various parameters as discussed in subsequent processes. Next, the timing of the transmission is determined in stage 606, and the content is transmitted in stage 608.

FIG. 6B relates to an exemplary process 610, which specifically relates to determining the timing of the transmission from stage 606 in FIG. 6A. In this process the user first selects the time of day in stage 612 for transmitting the content. Next, in stage 604, the user selects the date. Then, in stage 616, the user selects the time zone. Optionally, the order of these stages may be changed but all three parameters are preferably selected.

FIG. 6C relates to a process 916 for broadcasting video. It starts with uploading the video in stage 917, after which it is determined whether the video is breaking news. If it isn't then the normal broadcast flow occurs as described with regard to FIG. 6D, as shown in stage 919, and the process ends in stage 920.

If it is, then in stage 921, the distribution range is selected. Optionally this involves selecting one or more channels in stage 922, geolocation in stage 923, whether the content can only be accessed by paying subscribers in stage 924 and the type of content in stage 925.

The broadcast then automatically occurs after transcoding, in stage 926. The process then ends in stage 926a.

FIG. 6D shows a process 632 for determining for how long the content will be available. This process would typically be performed after stage 606, but before stage 608. Optionally, this particular process could be performed any time before stage 608, that is before the content is transmitted. In stage 634 the user determines state one for availability. For example, when content will first become available. Next, in stage 636, the user selects the time frame for state when, such as for example a particular day, 24 hour period, 48 hour period, week, et cetera.

Next, in stage 638, the user determines state two availability. State two may optionally be, for example, no longer available, no longer available for sharing, available for sharing, et cetera. The user then sets time frame to for state two in stage 640. Optionally, if content is no longer to be available and this state is not to be changed, then the time frame may optionally start at a particular date and time and simply not finish. Or it may start at a particular date and time, and run for a particular time period, after the user has viewed the content. Again, such a process may optionally not finish.

Alternatively, if this is related to sharing, then the date and time may optionally be set for a particular period of time but may then end. Optionally, multiple states are set, so for example state one could relate to when the content is available to the users, state two could relate to when the content is available for sharing, and then state three could relate to when the content ceases to be available. Multiple other states of course are also possible and are encompassed in this process.

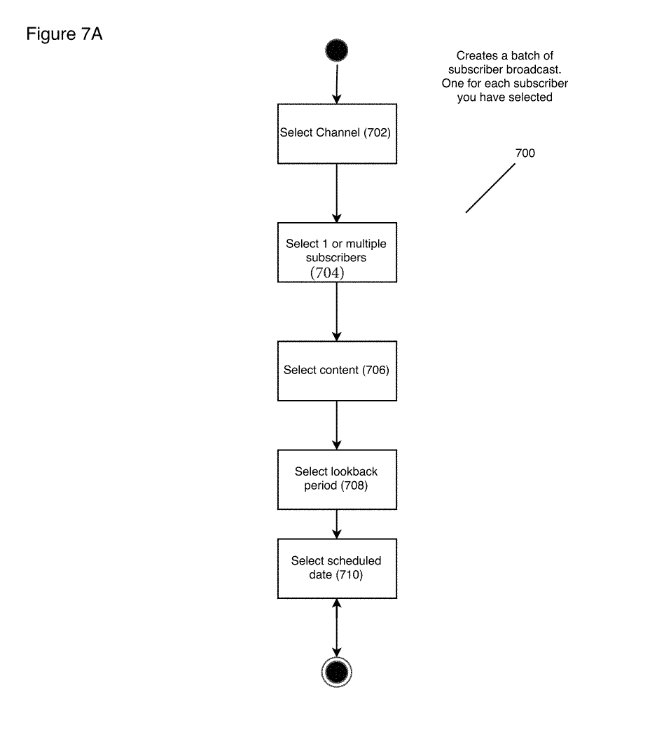

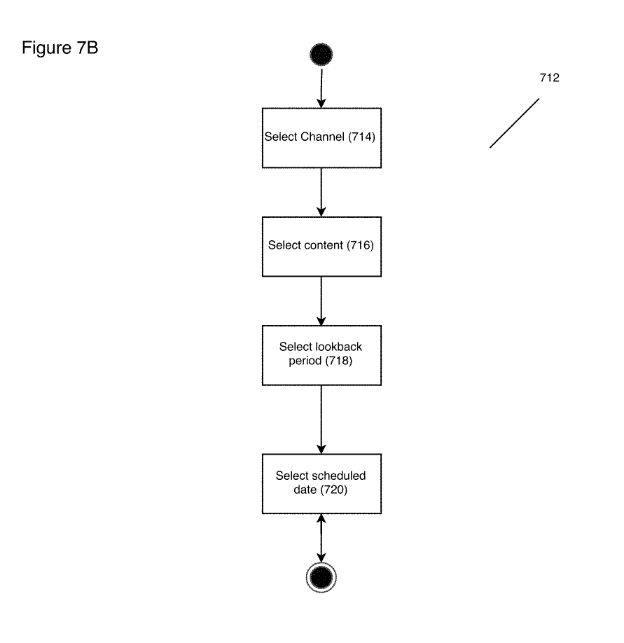

FIGS. 7A-7B show exemplary methods for setting up batch transmissions. FIG. 7A relates to a process 700 for creating a batch of material for subscriber broadcast. Optionally, the batch would be performed for the plurality of the subscribers selected or for a particular subscriber selected. Process starts in stage 702 with selection of the channel or channels, to which, subscribers need to be subscribed in order to receive the content. In stage 704 one or more subscribers is selected, this may optionally relate to a subset within the particular channel, such as for example not all subscribers to a channel but subscribers to a channel who have not opened content or not viewed content, their time, creative time and so forth.

In stage 706 content is selected to be transmitted, such as a video file for example. In stage 708 the lookback period is selected, which for example, is when the video is available and for how long it is available for display, and optionally also when it is available for social sharing. In stage 710, the data is scheduled for the initiation of transmission.

FIG. 7B relates to a process 712, for transmitting to a particular subscriber or all subscribers within a channel. Again, a channel is selected in stage 714, and content selected in stage 716. The lookback period is selected in stage 718 and the schedule date is selected in stage 720.

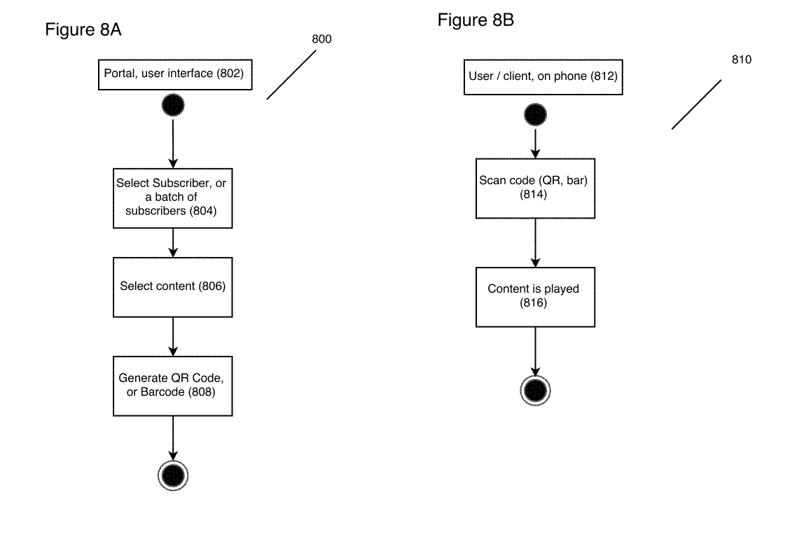

FIG. 8A relates to a process for generating a QR code of barcode to induce the user to view content. In process 800, starting with stage 802, the user goes to the portal or user interface in order to initiate the process. The user then selects the subscriber or batches of subscribers in stage 804. Content to be transmitted is then selected in stage 806. A QR code or barcode is generated in stage 808. This QR code or barcode is then used for the next process and shown in FIG. 8b, which is process 810. The user or client receives the QR code or barcode on phone 812. Or, alternatively, the user may scan the code, QR code or barcode, in stage 814. For example, the code is scanned for a message received on a different screen or for a message which has been printed, rather than for a message sent to the user's phone. Next, the content is played in stage 816.

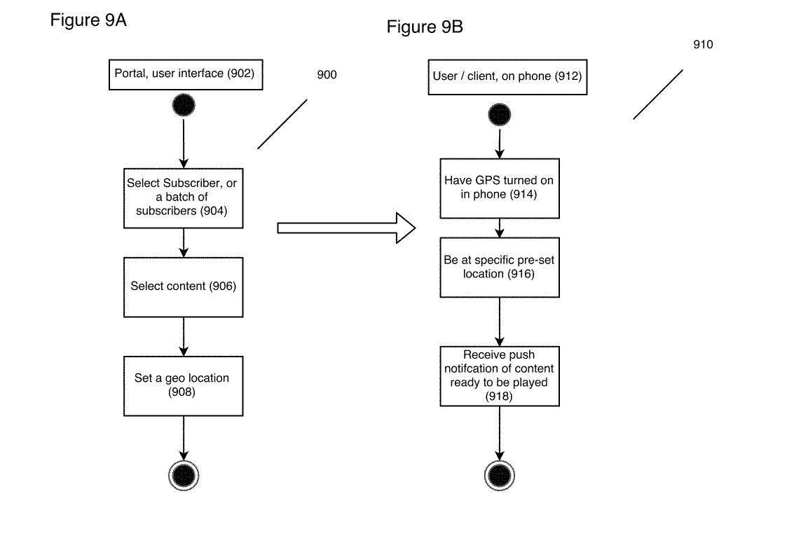

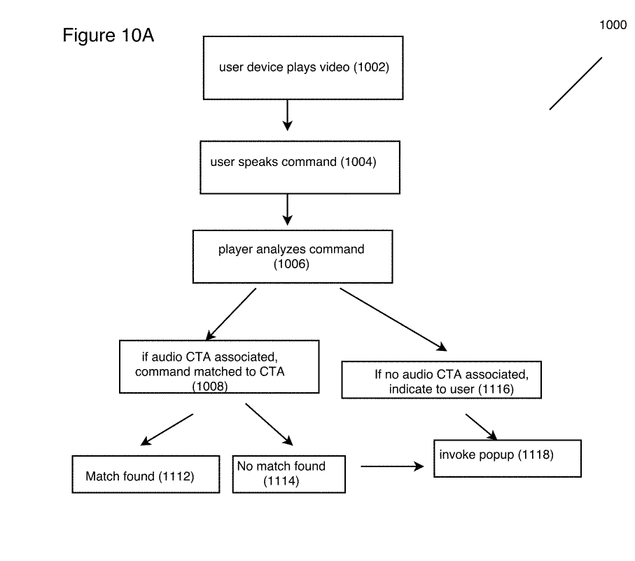

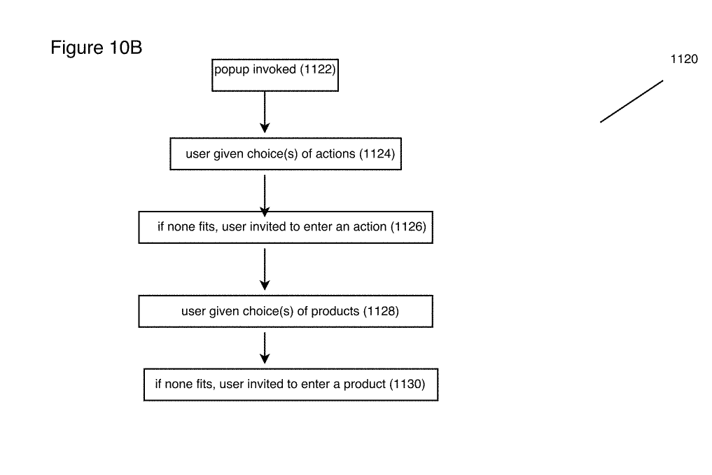

FIGS. 9A and 9B relate to a particular geolocation, in which content is sent to a user according to a particular geolocation. FIG. 9A shows a process 900, which the user begins the operation at the portal or user interface in stage 902, selects a subscriber or batch of subscribers in stage 904. Content is selected in stage 906. Next, a geolocation is set in stage 908. The geolocation information is sent to the user or client on phone 912, or alternatively may not be sent in advance so the user may not be aware of this. In any case, the user or client operating the phone in stage 912 has the GPS turned on in the phone in stage 914, or else turns it on in response to a prompt. The user, or at least the phone, would need to be at a specific preset location in stage 916. And then the user would receive through the phone a push notification of content ready to be played in stage 918. However, if the user's phone was not at that particular geolocation, then it would not receive the push notification of the content.

FIG. 10A relates to a process 1000, which features an audio CTA or call to action. In this non-limiting example, the video includes a call to action as previously described which may optionally be invoked by the user through an audio command. In stage 1002, the user device plays the video. In stage 1004, the user speaks a command, such as ‘buy’ or ‘buy now’. In stage 1006, the video player analyzes the command. Optionally the video player is not a complete standalone player but is an interface or overlay to an existing player. If the audio CTA is found to be associated or is connected then the command is matched to the CTA or call to action in stage 1008.

If a match is found in stage 1012, then the action is taken, for example the user maybe brought to a menu or website to purchase a particular product, they may optionally be allowed to do so through audio commands, or they may be required to enter some information such as credit card details or other contact details in order for the purchase to occur. If no match is found in stage 1014, then a pop-up is invoked in stage 1018. This pop-up preferably includes a request for the user to type in the command, or to indicate what the user wants to know. If this command can be matched then optionally the process proceeds back to stage 1012 for the match found.

If no audio CTA is associated with the video, this is indicated to the user in stage 1016, and preferably again the pop-up is invoked in stage 1018. If the user enters a command which matches a command known to the software, then optionally it proceeds to match found 1012, otherwise alternatively the user is requested to indicate in a message to the transmitter of the video, the content, or alternatively to a third party, what the user would like to receive or do.

FIG. 10b shows a process 1020. As shown, once the pop-up is invoked in stage 1022, the user is optionally given a choice of actions in stage 1024, such as for example buy the product, receive more information, sign up for a free trial, et cetera. If none of the actions fits the user's to enter an action manually in stage 1026. The manual action may optionally require the user to be in communication through email, text message, or optionally through a chat box, with the sender of the video or a third party.

The user is then given a choice of products in stage 1028 to fit the actions, so for example let's buy which product is to be bought. Optionally, the products are ranked according to the frame of the video, so for example depending on when the user stated the buy action, certain products or a particular product may optionally be associated with that time period. If none of the product choices fits then the user is invited to enter a product in stage 1030, and again this may optionally require an email message to be sent to a third party or to the sender of the video.

While the invention has been described with respect to a limited number of embodiments, it will be appreciated that many variations, modifications and other applications of the invention may be made, including different combinations of various embodiments and sub-embodiments, even if not specifically described herein.

What is claimed is:

1. A system for efficient, asynchronous video data delivery, comprising a mobile device and a video delivery platform, wherein said mobile device comprises a display for displaying video information and a microphone for receiving audio information, wherein said video delivery platform notifies said mobile device of availability of a video clip according to a notification message and wherein said mobile device pulls said video clip from said video delivery platform according to said notification message when said mobile device is connected to a network technology that does not involve cellular telephone network data delivery, receiving an audio CTA (call to action) from the mobile device and then performing a command according to the audio CTA.

2. The system of claim 1, wherein said network technology comprises WiFi.

3. The system of claim 1, wherein said audio CTA comprises a voice command spoken into the microphone of the mobile device and wherein said command invokes a further display of information on said display.

4. The system of claim 3, wherein said further display of information comprises displaying another video, a website or a combination thereof.

5. The system of claim 3, wherein said display parameters relate to one or more of when, how, to whom and for how long the video clip can be displayed on the mobile device.

6. The system of claim 5, wherein said mobile device pulls said video clip from said video delivery platform according to said notification message when said mobile device is connected to a network technology that does not involve cellular telephone network data delivery.

7. The system of claim 6, wherein said mobile device pulls said video clip from said video delivery platform according to said notification message when said mobile device is connected to a network technology that does not involve cellular telephone network data delivery or when said mobile device is connected to a cellular telephone network.

8. The system of claim 7, further comprising providing an interactive video for said video clip.

9. The system of claim 8, further comprising a CTA (call to action) functionality that links to and/or launches external content or in-app content.

10. The system of claim 9, wherein said content comprises an external website, a landing page, a “click to call” to perform an internet call or chat, or a telephone call or chat, an email, another video, an audio file and the like.

11. The system of claim 10, wherein said CTA functionality is provided through pre-roll or post-roll.

12. The system of claim 11, further comprising analyzing user behavior in regard to interacting with the video clip by said video platform.

13. The system of claim 3, further comprising an app, wherein said mobile device operates said app, wherein notification message comprises a URL and the app retrieves the video clip from said URL.

14. The system of claim 13, further comprising a CDN (content delivery network) for providing the video clip for retrieval by said app, wherein said video delivery platform is separate from said CDN.

15. The system of claim 14, further comprising a transcoder for transcoding the video clip before retrieval by said app.

16. The system of claim 13, wherein said video delivery platform further comprises a CDN (content delivery network) for providing the video clip for retrieval by said app.

17. The system of claim 16, further comprising a video publisher for publishing the video clip and a public API to said video delivery platform for receiving the video clip from said video publisher.

18. The system of claim 17, wherein said video delivery platform further comprises a plurality of tenants, wherein each video publisher provides videos to at least one tenant and wherein tenant provides connectivity to said CDN.

19. The system of claim 4, wherein when a video clip is displayed is determined according to a time zone of the mobile device.
